(19) United States
(12) Patent Application Publication
(10) Pub. No.: US 2006/0096106 A1
(43) Pub. Date: May 11, 2006

(54) Guide with zero point return

(76) Inventor: Guido Tschopp, Zunzgen (CH)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 10/520,575

(22) PCT Filed: Mar. 24, 2003
(86) PCT No.: PCT/CH03/00188

§ 371 Date: Aug. 15, 2005

(30) Foreign Application Priority Data
Jul. 10, 2002 (CH) 1210/02

(51) Int. Cl. G01C 9/12

(52) U.S. Cl. 33/402

(57) ABSTRACT

A guide with zero-point resetting is presented in the form of a series pendulum which permits the amplitude of the pendulum to be used horizontally. The guidance is carried out in the region of the segment of a spherical surface, in whose mid-axis the gravity directed towards the earth and acting vertically acts.

The present invention relates to a guide with zero-point resetting according to the precharacterizing clause of Patent claim 1.

In industrial application and in daily life, there is in many sectors a requirement to set up objects and devices without these emitting vibrations or horizontal movements to the environment or picking these up from the said environment. In order to be able to keep horizontal movements away from the desired object, for example pendulums or universally jointed suspensions (gyroscopic compass) are used. With a simple suspension of the object to be decoupled by means of a pendulum, neither are inherent movements of the object transmitted to the environment nor are vibrations of the environment transmitted to the object. Pendulum devices of this type have the disadvantage, however, that they are set into a free swinging movement as a result of relative movement between object and environment. Another fact, which is desired under certain circumstances, is that vertical relative movements are transmitted through the pendulum without damping, via the pendulum cord and its suspension points.

Applications are found where movements and vibrations are produced which it is not wished to transmit. Such devices are used in seismographs for measuring movements of the earth as a result of earthquakes. In mechanical engineering, highly precise machines and particularly heavy machines that generate vibrations, such as forging presses and forging hammers, are insulated from the environment by means of floating foundations or special suspensions, such that vibrations are not transmitted between machine and environment. For example, many years ago, the mounting of machines which either produce great vibrations or have to satisfy high precision requirements has been placed on dedicated foundations of great mass. In order to protect these foundations against horizontal and vertical movements and vibrations, the foundations have been cushioned with respect to the environment.

They have been placed in concrete troughs and the foundations have been insulated with respect to bottom and walls of these troughs by soft means, such as cork layers, etc, and in this way protected against mutual bodily transmission of shocks and oscillations between trough and foundation. Suspensions which are used in seismographic measuring instruments offer the possibility of automatic zero-point resetting.

On the lower, freely swinging part of the pendulum there is a pin which writes on a recording chart. Over the course of a day, this drawing board moves relative to the pin. It is firmly connected to a foundation, to which the suspension of the pendulum is fixed. Suspended at the lower end of the pendulum is a mass, to which the writing device is fixed. As a result of the movement of the recording chart, without any relative movement between foundation and mass a straight line is produced on the said recording chart. Now, if the foundation moves, because an. earthquake transmits earth shocks to the same, the mass remains stationary in the first instant, as a result of its own inertia. Then, as a result of the positions of the suspension point on the foundation being displaced from the perpendicular in relation to the fixing point of the mass, it begins to oscillate, since a pendulum will always find its way back to the vertical position, that is to say into the “zero-point position”. This behaviour of the mass, that is to say the relative movement between mass and foundation, is recorded on the recording chart as zigzag excursions with respect to the original straight line. This relative movement is damped in order to have the instrument in the initial position again within a sensible period of time and the instrument is therefore ready for the next recording.

The invention is based on the proposition that, on one hand, the freely suspended mass is decoupled from the direct influence of movement of the environment. It can then itself be set into harmonic oscillation without being prevented from this by a rigid environment. For instance, it is known that harmonic oscillating movements promote sleep. For centuries, mothers have rocked their infants and toddlers in a cradle or in their arms in order to have them go to sleep. It is therefore obvious to construct beds and couches which follow a swinging movement. The simplest of the possibilities should be a cradle or swing hammock suspended from the ceiling by one, two or more cords.

Known embodiments of beds and sofas are described, for example, in patent numbers CH 667 000 and EP 0 102 546. In all the known texts, an entire bed or sofa frame is provided with an apparatus which effects a pendulum-like movement of the couch. Many of these embodiments proposed in the patent literature have also been constructed, sold and used commercially. Nevertheless, the proposed devices are complicated, expensive and impractical. In order to implement the idea, a complete and correspondingly expensive bed construction has to be made.

In addition to this application in the area of sleeping comfort, the idea is also important for technical equipment and applications. In industry, for example, pendulums are used with and without damping. Systems for damping multiple pendulums are presented under the number JP 1131353 or WO 9202745. Such technical solutions are always conceived specifically for an application. There is no contrivance of the inventive type which could be used as an independent contrivance for various applications.

The object of the present invention is to implement a guide with zero-point resetting which makes use of the advantages of the zero-point resetting of a pendulum, has a small overall height and, by using the appropriate principle, exhibits high inherent damping and great amplitude, use being made of the fact of the small vertical movement which results when a long pendulum cord with a small excursion is used, without having the disadvantage of the overall height given by the long pendulum cord.

This object is achieved by the guide with zero-point resetting having the features of Patent claim 1. Further features according to the invention emerge from the dependent claims and their advantages will be explained in a following description.

In the drawing:

FIG. 1 shows a mathematical pendulum.

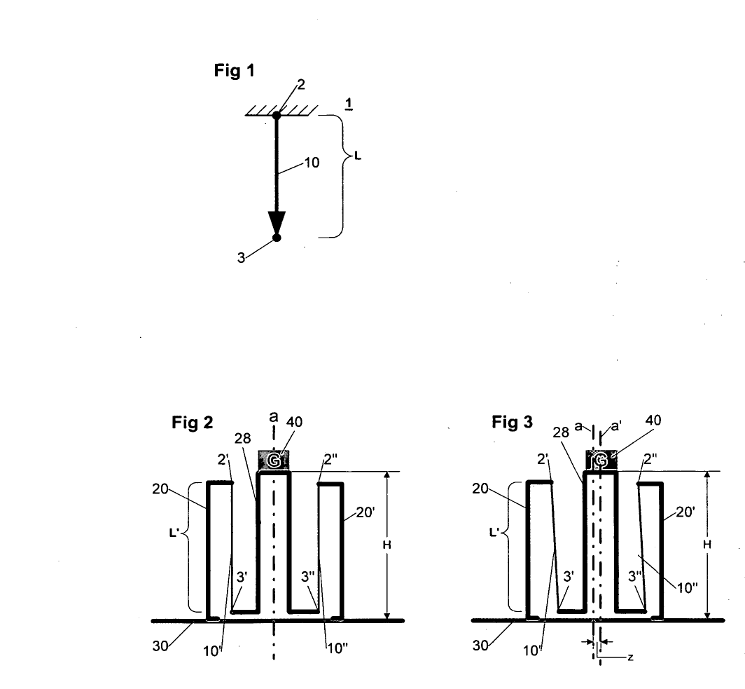

FIG. 2 shows the principle of the series pendulum of first order.

FIG. 3 shows the principle of the series pendulum of first order with a deflection.

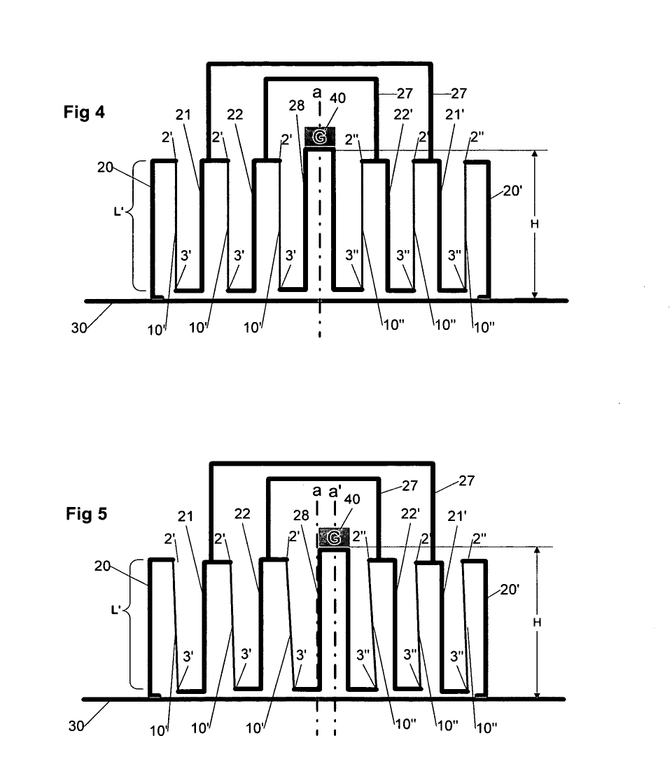

FIG. 4 shows the principle of the series pendulum as a guide with zero-point resetting with inherent damping.

FIG. 5 shows the principle of the series pendulum as a guide with zero-point resetting with inherent damping with a deflection.

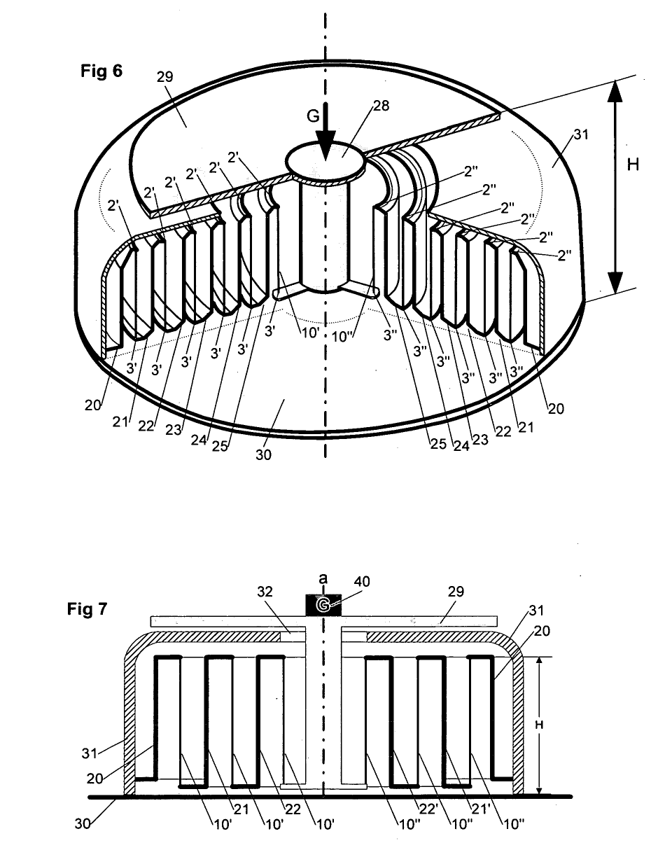

FIG. 6 shows a perspective view of a series pendulum as a guide with zero-point resetting.

FIG. 7 shows a section of a series pendulum as a guide with zero-point resetting.

The figures represent preferred exemplary embodiments, which will be explained by the following description.

FIG. 2 shows the principle of a guide with zero-point resetting of the type presented. In the system presented, the fixing 2 located at the top in the case of a physical pendulum is supported on a plate 30 asserted by means of a base 20. In this way, height H becomes only slightly longer than the length L′ of the cords 10′, 10″ of the series pendulum. In the two-dimensional system presented in FIG. 2, the two cords 10′, 10″ keep the system in symmetrical equilibrium, the mid-axis a being able to swing parallel to the base 20 (20′, 20″) on the cords 10′, 10″ to the new axis a′ of the carrier 28 with an amplitude z (FIG. 3). The axes a, a′ , the vertical alignment of the bases 20′, 20″ and the vertical position of the carrier 28 are always parallel to one another. Only the cords 10′, 10″ exhibit a deflection by the amplitude z. In the deflected position illustrated in FIG. 3, the height H becomes greater than in the original initial position as illustrated in FIG. 2. In this case, the carrier 28 will come to lie higher as compared with the initial position. On the other hand, as a result of the action of the force of gravity, it will have the tendency to return into the lowest position of the series pendulum (as illustrated in FIG. 2).

In order to increase the length of the cord 20 by a multiple without having to add to height H, systems can be built in one another (FIG. 4). An intermediate carrier 21 is built into the base 20, 20′ by means of cords 10′, 10″. An intermediate carrier comprises, for example, two parts 21, 21′, which are connected firmly to each other via a connecting web 27. On this intermediate carrier 21, a further intermediate carrier 22 is suspended, and on the latter, the carrier 28 holding the load 40 and the weight G is suspended. This system can in principle be multiplied with any desired number of intermediate carriers, each intermediate carrier, for example comprising two intermediate carrier parts, being firmly connected to one another via a connecting web 27. Given a constant length L′of the cords 10, the actual length of the cord 10 is multiplied to n x L. The formula:
n×L′=L
applies, where n represents a number of carriers and cords 10, respectively. The height H is independent of the length L of the cord.

This previously two-dimensionally described device can likewise be applied in the three-dimensional system. FIG. 6 is a representation of such a three-dimensional system. By way of example, this describes that the cords 10′, 10″, 10′″, to which the carriers one, two, three, etc. are fixed at the positions 2′, 2″, 2′″, are fixed on a circumferential line at at least three positions 2. This system oscillates in the plane parallel to the plate 30 of the base.

An exemplary embodiment will be explained on the basis of FIG. 6. A base 20 is fixed to a plate 30 having a housing 31. A three-dimensional, for example annular, carrier 21 is suspended via three cords 10′, 10″ and 10′″ (only 10′ and 10″ are visible in FIG. 6) distributed uniformly on the circumference of the annular base 20. A further carrier 22 is suspended in the same way on this carrier 21 and on this carrier 23, etc. The cords 10 are in each case fixed to the fixing points 2 at the top on the base or carrier 21, 22, 23, 24, etc. and to the fixing points 3 at the bottom on carrier 21, 22, 23, 24, etc.

The actual carrier 28 is connected to a carrier plate 29. This carrier plate 29 can project beyond the central passage opening 32, in order that the guide with zero-point resetting can be offered on the market as a closed capsule (FIGS. 6, 7). However, it is also possible to connect the carrier 28 directly to a load. Such capsules can be placed in any desired number over any desired body and will carry this body or just this load 40 having a weight G freely floating with respect to the environment.

In order to ensure this, the fixing points 2 and 3 should permit all degrees of freedom of movement for the oscillation of the carrier suspended thereon. The invention has been based, for example, on a support for the support of a bed. If the cords 10 are replaced by tie rods and the same are made fast at the fixing points 2 and 3 by means of roller bearings with an appropriate degree of freedom, for example with a self-aligning bearing, the device can be used for large loads. As a result, industrial applications are also conceivable for the subject-matter of the invention.

Nevertheless, a classical application remains the oscillating mounting of beds, in particular cots, mentioned at the beginning.

1. Guide with zero-point resetting in the region and on the path along a spherical surface, characterized in that the base (20) is connected to plate (30), the base (20) comprising a pair of bases (20, 20′) firmly connected to each other via plate (30), to whose fixing points (2′, 2″) at least two equally long connections (10′, 10″) are fixed such that they can move, to whose other ends (3′, 3″) there is fixed a carrier (28) which holds a load (40) with the weight G.

2. Guide with zero-point resetting according to claim 1, characterized in that between base (20) and carrier (28) there is arranged at least one intermediate carrier (21), which comprises a pair of intermediate carriers (21, 21′) firmly connected to each other by means of a connecting web (27), the intermediate carrier (21) being connected to the base (20) by means of at least two equally long connections (10′, 10″) via fixing points (2, 2′) and being connected to the carrier (28) via at least two equally long connections (10, 10′) via fixing points (3, 3′).

3. Guide with zero-point resetting according to claim 1, characterized in that the base (20), the carrier (28) and intermediate carrier (21) are annular and arranged concentrically.

4. Guide with zero-point resetting according to claim 1, characterized in that the base (20), the carrier (28) and intermediate carrier (21) are shaped as desired.

5. Guide with zero-point resetting according to claim 1, characterized in that the base (20), the carrier (28) and intermediate carrier (21) are arranged as desired.
